(19) United States
(12) Patent Application Publication
(10) Pub. No.: US 2022/0398437 A1
(43) Pub. Date: Dec. 15, 2022

(54) Depth-Parallel Training of Neural Networks

(71) Applicant: DeepMind Technologies Limited, London (GB)

(72) Inventors: Mateusz Malinowski, London (GB); Viorica Patraucean, London (GB); Grzegorz Michal Swirszcz, London (GB); Joao Carreira, St. Albans (GB)

(21) Appl. No.: 17/777,131

(22) PCT Filed: Nov. 13, 2020
(86) PCT No.: PCT/EP2020/082023

§ 371 Date: May 16, 2022

Related U.S. Application Data
(60) Provisional application No. 62/936,330, filed on Nov. 15, 2019.

(51) Int. Cl. G06N 3/04; G06N 3/08

(52) U.S. Cl. CPC G06N 3/0472; G06N 3/08

(57) ABSTRACT

Methods, systems, and apparatus, including computer programs encoded on computer storage media, for executing depth-parallel training of a neural network. One of the methods includes receiving an input sequence; and at each processing time step in a sequence of processing time steps: processing an input item using a first layer block in a stack of layer blocks to generate a first block output; for each subsequent layer block, processing a block output generated by the preceding layer block at the preceding processing time step to generate a current block output; computing i) a current error in an output item generated by the final layer block and ii) a current gradient of the current error; generating a parameter update for the final layer block; for each particular layer block that is not the final layer block, computing a current gradient for the particular layer block and generating a parameter update.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a neural network configured to process an input sequence to generate an output sequence. In particular, the system can perform depth-parallel training of the neural network. In this specification, a training system performs depth-parallel training of a neural network if the system, during training, processes multiple different network inputs using respective different neural network layers of the neural network in parallel.

The system can perform depth-parallel training by executing multiple “forward passes” and multiple “backward passes” in parallel. In this specification, a “forward pass” of a neural network refers to operations whereby a system processes a network input using the neural network to generate a network output corresponding to the network input. In this specification, a “backward pass” of a neural networks refers to operations whereby a system updates the parameters of the neural network using an error in a network output generated by the neural network in response to a network input.

Using existing techniques, when training a neural network that includes multiple neural network layers, a training system typically must perform the entire forward pass and backward pass corresponding to an input item before beginning to process the subsequent input item in the input sequence. This is because, for each neural network layer, the training system uses the layer output generated by the neural network layer during the forward pass in order to update the parameters of the neural network layer during the backward pass. Therefore, if the neural network includes N neural network layers, then it takes approximately 2N processing time steps for a training system to process an input item (N processing time steps for the forward pass and N processing time steps for the backward pass), during which time the training system cannot process any other input items in the input sequence. Thus, for an input sequence that includes k input items, it takes approximately 2Nk processing time steps for the training system to process the input sequence.

Using techniques described in this specification, a training system can approximate, for each neural network layer of the neural network, the layer output corresponding to a first input item using the layer output corresponding to a second input item that is later in the input sequence than the first input item. Therefore, the training system does not need to wait until the completion of the full forward pass and backward pass of the first input item before processing the second input item. In particular, at each processing time step, each neural network layer of the neural network can generate a layer output corresponding to a respective different input item of the input sequence. Thus, the training system can process an input sequence having k input items in approximately k+2N processing time steps.

Particular embodiments of the subject matter described in this specification can be implemented so as to realize one or more of the following advantages.

As described above, the time complexity of processing an input item using existing techniques is O(Nk), where N is the number of neural network layers in the neural network and k is the number of input items in the input sequence. The time complexity of processing an input item using techniques described in this specification is O(N+k). This represents a significant improvement in efficiency, reducing the time required to train the neural network.

Using techniques described in this specification, a training system can further reduce the memory requirements of training the neural network. In particular, because the training system uses, for each neural network layer, the layer output corresponding to a first input item to approximate the layer output corresponding to a second input item, the training system does not need to store in memory the respective layer outputs corresponding to every input item in the input sequence. Additionally, by eliminating the requirement for the training system to maintain a memory store for the layer outputs and to retrieve respective layer outputs when required, the techniques described herein can further improve the computational and time efficiency of the training system.

Some systems described in this specification can approximate the layer output corresponding to a first input item in an input sequence using the layer output corresponding to a second input item in the input sequence by relying on an assumption that the first input item and the second input item are reasonably similar. For two input items that are proximate to each other in the input sequence (e.g., that are within 1, 10, or 100 input time steps of each other), this is typically a valid assumption, allowing the system to generate highly accurate parameter updates for the neural network layer.

Thus, some implementations of the described systems provide an alternative to backpropagation that leverages processing that is effectively local, determining gradients which are only approximate because they are based on layer outputs from different time steps and thereby exploiting smoothness in the input sequence. Counter-intuitively this may provide some additional regularization, helping the system to generalize. Correspondingly, in a setting where the parameters of the system are required to adapt quickly, this is facilitated by avoiding the inherent delay introduced by propagating data first in the forward direction and then in the backward direction. The described techniques have general applicability, but some implementations of the system are useful for processing temporal sequences such as input items comprising frames of video or audio data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates the operations of an example prior art training system.

FIG. 2A and FIG. 2B illustrate the operations of an example training system

FIG. 3 is a block diagram of an example training system.

FIG. 4 is a flow diagram of an example process for training a neural network.

Like reference numbers and designations in the various drawings indicate like elements.

### DETAILED DESCRIPTION

This specification describes a training system that parallelizes the operations of training a neural network that has multiple neural network layers. The neural network is configured to receive an input sequence having a respective input item at multiple input time steps, and to process the input sequence to generate a network output.

The neural network processes the input sequence to generate an output sequence, where each output item in the output sequence corresponds to a respective input item in the input sequence. An output item is sometimes also called an “item output” corresponding to an input item.

In some implementations, after processing each input item in the input sequence, the neural network generates the network output using the respective output items. For example, the network output can be the average of the output items. As another example, the network output can be one of the output items, e.g., the final output item (i.e., the output item corresponding to the final input item in the input sequence). In some implementations, the network output can itself be a sequence, e.g., the sequence of generated output items. Thus in general the network output may be generated from one or more of the output items.

The input sequence can be composed of input items of any appropriate type.

In some implementations, the input sequence is a video sequence, where each of the input items is a frame in the video sequence. The network output may then be trained to characterize the video sequence, e.g., a still or moving content of the video sequence. For example, the neural network can be configured to generate a class prediction for the video sequence. As particular examples, the neural network can predict that the video sequence depicts an object, e.g., a “dog”, an “ocean”, or a “car”; or one of a set of recognized actions; or the presence of one or more of a set of recognized conditions depicted within the video sequence (e.g., time of day, weather conditions, etc.); and so forth. In this example, the output item corresponding to a given frame in the video sequence can be a vector of predicted probabilities, where each predicted probability in the vector characterizes the likelihood that a corresponding class is depicted in the frame. The neural network output can also be a vector of predicted probabilities, where each predicted probability in the vector characterizes the likelihood that a corresponding class is depicted in the video sequence. In another example, the output items can include a compressed representation of the video sequence. In another example, the output items can include, or be used to generate, output video frames, e.g., to infer a video frame property from the input frames of the input video sequence, such as image depth or color for the input video frames.

In some other implementations, the input sequence is an audio sequence of human speech, where each input item represents an audio sample or a group of audio samples. For example, the input items can each include digitized raw or processed audio data. As another example, the input items can each be a spectrogram computed from raw audio data or a representation of a frame of audio data in the time-frequency domain. In some implementations, the neural network can generate a prediction of the phonemes or words spoken in the audio sequence; i.e., the neural network can be a “speech-to-text” neural network.

In some other implementations, the input sequence is a text sequence, where each input item represents a text sample, e.g., words in a first natural language. For example, each input item can be an embedding of a character, phoneme, or word. In some implementations, the neural network can generate audio corresponding to the input text sequence; i.e., the neural network can be a “text-to-speech: neural network. In some other implementations, the neural network can generate an output text sequence corresponding to the input text sequence, e.g., a translation of the input text sequence into a second, different natural language.

In some other implementations, the input sequence is a sequence of health data for a particular patient, where each input item represents medical data of the patient. The network output can then characterize a health of the patient or predict a future health of the patient.

In some other implementations, the input sequence is a sequence of data characterizing a physical environment over time. For example, the sequence of data can include lidar, radar, or ultrasound data. In some implementations, the network output can characterize a prediction about the physical environment. In some other implementations, the network output can identify an action to be taken by an agent operating in and/or interacting with the physical environment, e.g., a selection of a particular action from a set of possible actions.

In some other implementations, the input sequence is a sequence of data drawn from an input sample, such as image, audio, or text data, and the output sequence is a compressed or encoded representation of the input sample. For example, the neural network may be or be part of an encoder, e.g., trained as part of an autoencoder system, such that the output data items represent a compressed latent variable representation of the input data items. A decoder, e.g., a decoder of the autoencoder system, may then be used to decode the output data items to recover the input data items.

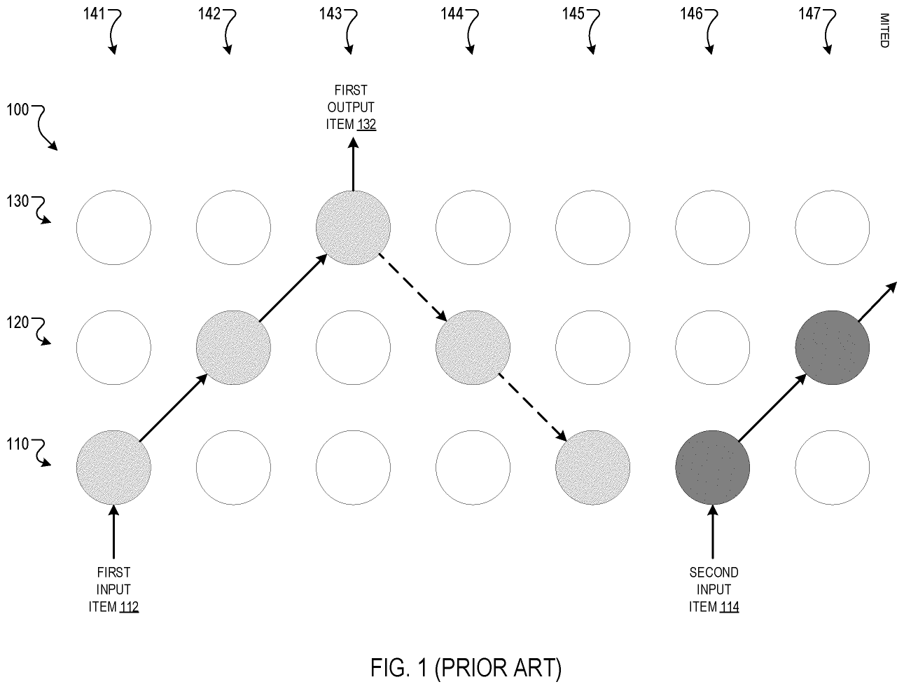

FIG. 1 illustrates the operations of an example prior art training system. The prior art training system is configured to train a neural network 100 that includes a stack of three layer blocks 110, 120, and 130 (represented by circles in FIG. 1). The neural network 100 is configured to process input items in an input sequence to generate a respective output item for each input item. Each layer block 110-130 includes one or more neural network layers.

The first layer block 110 is configured to process an input item in the input sequence to generate a first block output. Each subsequent layer block 120 and 130 are configured to process the block output of the preceding layer block in the stack of layer blocks to generate a respective block output. The block output of the final layer block can be the output item for the corresponding input item.

FIG. 1 illustrates the operations of the neural network across multiple processing time steps 141-147. If the circle corresponding to a particular layer block 110-130 at a particular processing time step 141-147 is white, this indicates that the particular layer block does not execute operations during the particular time step. If the circle corresponding to a particular layer block 110-130 at a particular processing time step is a shade of gray, this indicates that the particular layer block executes operations corresponding to an input item identified by the shade of gray. In particular, a first input item 112 is identified by a light gray color, while a second input item 114 is identified by a darker gray color.

The prior art training system trains the neural network using one input item of the input sequence at a time. In particular, in the first processing time step 141, the prior art training system processes the first input item 112 in the input sequence using the first layer block 110 to generate a first block output. The prior art training system provides the first block output to the second layer block 120 (represented in FIG. 1 as a solid arrow). In the second processing time step 142, the prior art training system processes the first block output to generate a second block output, and provides the second block output to the third layer block 130. In the third processing time step 132, the prior art training system processes the second block output to generate the first output item 132, which corresponds to the first input item 112.

After completing the forward pass, in the third processing time step 143, the prior art training system determines an error in the first output item 132. The prior art training system then determines an update to the parameters of the third layer block 130 according to the error in the first output item 132.

In the fourth processing time step 144 and the fifth processing time step 145, the prior art training system backpropagates the error in the first output item 132 to the second layer block 120 and the first layer block 110, respectively (represented in FIG. 1 as respective dashed arrows). For example, in the fourth processing time step 144, the prior art training system can use a gradient of the error computed in the third processing time step 143 to determine an update to the parameters of the second layer block 120, and in the fifth processing time step 145 the prior art training system can use a gradient of the error computed in the fourth processing time step 144 to determine an update to the parameters of the first layer block 110.

Notably, it is only after the prior art training system has completed the backward pass of the first input item 112 that the prior art training system can begin the forward pass of the second input item 114, in the sixth processing time step 146. This is because, while backpropagating the error in the first output item 132, the prior art training system required the second block output to update the parameters of the second layer block (in the fourth processing time step 144) and the first block output to update the parameters of the first layer block (in the fifth processing time step 145). Thus, these prior art techniques do not allow for parallelized training using multiple input items at once, thereby limiting the speed at which the neural network can be trained.

In the sixth processing time step 146, the prior art training system processes the second input item 114 using the first layer block 110, and continues the forward pass of the second input item 114 in the seventh processing time step 147 and beyond.

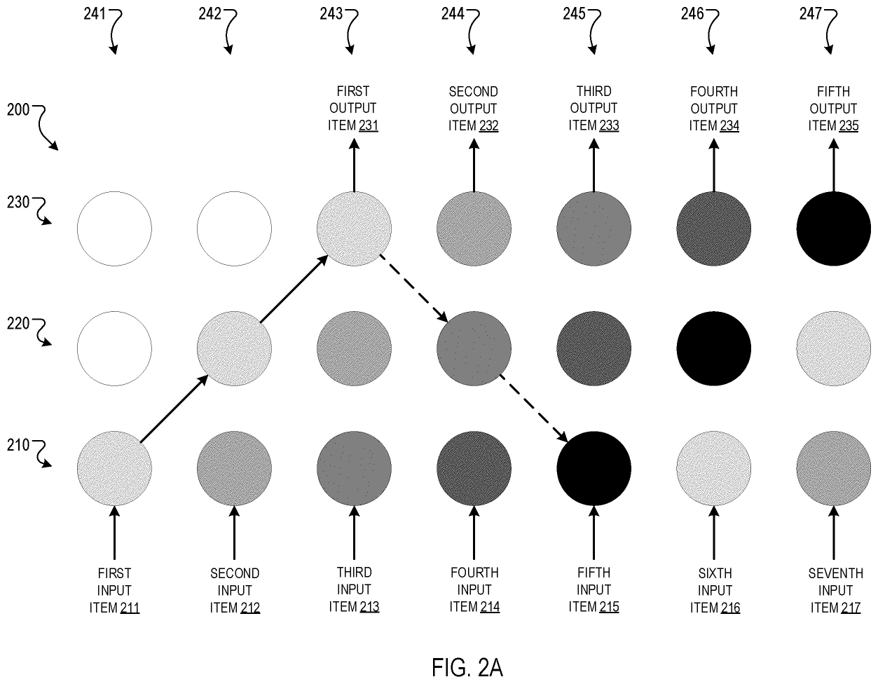

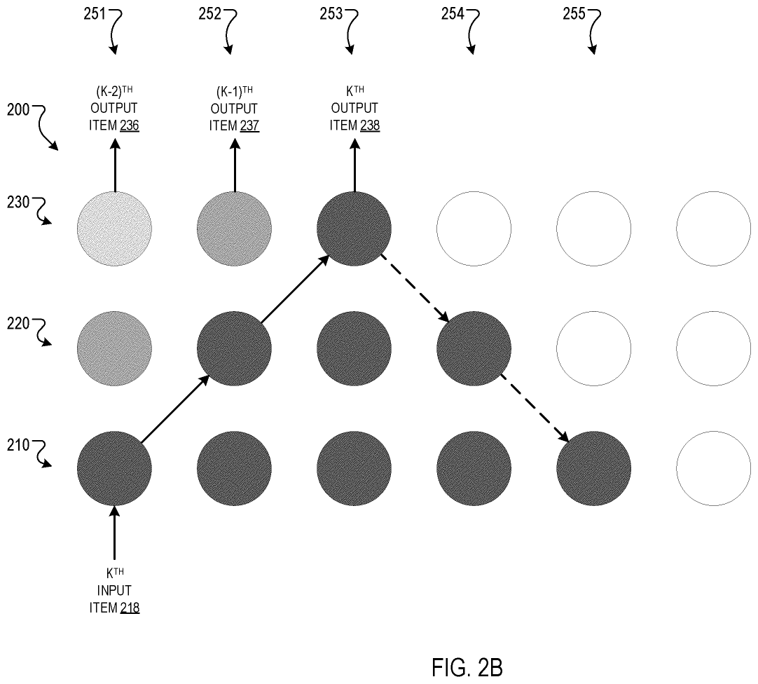

FIG. 2A and FIG. 2B illustrate the operations of an example training system that trains a neural network using the techniques described in this specification.

The training system is configured to train a neural network 200 that includes a stack of three layer blocks 210, 220, and 230 (represented by circles in FIG. 2). The neural network 200 is configured to process input items in an input sequence to generate a respective output item for each input item.

Each layer block 210-230 includes one or more neural network layers. The neural network layers can be of any appropriate type. For example, each layer block 210-230 can include one or more convolutional neural network layers, one or more feedforward neural network layers, and/or one or more recurrent neural network layers. Each layer block 210-230 can also include one or more normalization layers, e.g., batch normalization layers.

Although three layer blocks are depicted in FIG. 2, in general a neural network can have any number of layer blocks. As a particular example, the neural network can have a stack of 5, 10, or 100 layer blocks.

As described above, the first layer block 210 is configured to process an input item in the input sequence to generate a first block output. Each subsequent layer block 220 and 230 are configured to process the block output of the preceding layer block in the stack of layer blocks to generate a respective block output. The block output of the final layer block can be the output item for the corresponding input item. As a particular example, if a layer block includes a single neural network layer, then the block output of the layer block is the layer output of the neural network layer.

FIG. 2A illustrates the operations of processing the first few input items in the input sequence, and FIG. 2B illustrates the operations of processing the last few input items in the input sequence.

FIG. 2A illustrates the operations of the neural network across multiple processing time steps 241-247. If the circle corresponding to a particular layer block 210-230 at a particular processing time step 241-247 is white, this indicates that the particular layer block does not execute operations during the particular time step. If the circle corresponding to a particular layer block 210-230 at a particular processing time step is a shade of gray, this indicates that the particular layer block executes, at the particular time step, the forward pass of an input item identified by the shade of gray. In particular, a first input item 212 is identified by a light gray color, while each subsequent input item is identified by an increasingly darker gray color (until the sixth input item 216, when the color cycles back to the light gray color).

The training system is configured to process, at each time step 241-247, multiple different input items in respective forward passes and multiple different input items in respective backward passes. That is, each layer block is active in a given processing time step; this differs from the existing techniques described above, where only one layer block was active at a time.

For example, at each processing time step 241-247, the training system can perform a “forward step” and a “backward step.” In some implementations, at each processing time step 241-247, the training system can perform the forward step and the backward step in any order, or in parallel.

In the forward step for a given processing time step, the first layer block 210 processes a new input item, and each subsequent layer block 220 and 230 in the stack of layer blocks processes the block output generated by the preceding layer block in the stack of layer blocks at the preceding processing time step. Each layer block 210-230 is processing an input that originated at a different processing time step. That is, if the current processing time step is time step t, the first layer block 210 processes an item input in the input sequence that corresponds to time step t. The second layer block 220 processes a block output that originated from an item input that corresponds to time step t−1. The third layer block 230 processes a block output that originated from an item input that corresponds to time t−2. In general, layer block n processes a block output that originated from an item input that corresponds to time step t−n+1.

In the backward step for each processing time step, each layer block 210-230 in the neural network 200 executes a backward pass for an item input that originated at a different processing time step. Each layer block determines a parameter update using the block output of the layer block generated at the processing time step, i.e., the block output that originated from an item input that corresponds to time step t−n+1.

In particular, in the backward step for each processing time step, the third layer block 230 determines a parameter update using an error in the output item generated at the processing time step. Each preceding layer block 210 and 220 determines a parameter update using i) a preceding gradient generated by the subsequent layer block in the stack of layer blocks at the preceding processing time step and ii) the block input for the layer block in the current processing time step (i.e., the block output generated by the preceding layer block in the stack of layer blocks in the forward step of the preceding processing time step).

That is, each layer block except the final layer block in the stack of layer blocks determines a parameter update using two inputs (the preceding gradient and the preceding block output) that originated at input items corresponding to different processing time steps. Thus, the parameter update for each layer block except the final layer block is an approximation.

The training system can compute an error in the output item generated by the final, in this example third, layer block 230 in the forward step of the processing time step by processing i) the output item generated in the forward step of the processing time step and ii) a target, or “ground-truth”, output item corresponding to the input item from which the output item was generated, in order to determine the error in the output item. For example, the training system can compute the mean-squared error or cross-entropy loss. In general the error may be determined from a measure of a difference between the output item or a network output determined from the output item, and the target output item or network output. The training may be supervised, e.g., when the network output is a classification output, using labelled input sequences to train the neural network; or it may be unsupervised, e.g., when the neural network is part of an autoencoder.

The training system can then determine a first gradient of the computed error of the output item with respect to the block input of the final block at the processing time step (i.e., the block output generated by the preceding layer block in the stack of layer blocks at the preceding processing time step in the sequence of processing time steps), and pass the first gradient to the preceding layer block. The training system can also determine a second gradient of the computed error of the output item with respect to the parameters of the final layer block, and use the second gradient to generate a parameter update for the final layer block 230. For example, the training system can use gradient descent, e.g., stochastic gradient descent, to generate the parameter update.

Then, during backpropagation of the error to each particular layer block preceding the final layer block (except the first layer block) at respective subsequent processing time steps, the training system can again determine two gradients: a first gradient with respect to the block input of the particular layer block at the subsequent processing time step, which the system can pass to the preceding layer block in the stack of layer blocks to continue the backpropagation in the next subsequent processing time step; and a second gradient with respect to the parameters of the particular layer block, which the system can use to generate a parameter update for the particular layer block.

Finally, to backpropagate the error to the first layer block, the training system can determine a single gradient (corresponding to the “second” gradient described above) with respect to the parameters of the first layer block, which the system can use to generate a parameter update for the first layer block. That is, the training system does not determine a gradient (corresponding to the “first” gradient described above) with respect to the input to the first layer block because there are no layer blocks preceding the first layer block to which to pass such a gradient.

For convenience, in the below description, a “first” gradient of a layer block refers to a gradient with respect to the block input of the layer block at the current processing time step. A “second” gradient of the layer block refers to a gradient with respect to the parameters of the layer block.

Generally, if the current processing time step is time step t and there are D layer blocks in the neural network 200, the final layer block D determines an error of the output item generated in the forward step of time step t (where the output item originated from an input item in the input sequence that corresponds to time step t−D+1). The final layer block D can determine a first gradient of the error with respect to the block input of the final layer block D and a second gradient of the error with respect to the parameters of the final layer block D. The final layer block D can use the second gradient to determine a parameter update from the error.

At processing time step t, layer block D−1 determines the first and second gradients using i) the preceding gradient generated by layer block D in time step t−1, which originated from an input item in the input sequence that corresponds to time step t−D; and ii) the block output of layer block D−2 generated during the forward step of time step t−1, where the block output originated from an input item in the input sequence that corresponds to time step t−D+2. In general, layer block n, where 1<n<D, determines the first and second gradients using i) the preceding gradient generated by layer block n+1 in time step t−1, which originated from an input item in the input sequence that corresponds to time step t−2D+n+1; and ii) the block output of layer block n−1 generated during the forward step of time step t−1, where the block output originated from an input item in the input sequence that corresponds to time step t−n+1.

Referring back to FIG. 2A, in the forward step of the first processing time step 241, the first layer block 210 processes the first input item 211 to generate a first block output, and provides the first block output to the second layer block 220 (illustrated as a solid arrow). For clarity, only the arrows corresponding to the first input item 211 are illustrated in FIG. 2A, although it is to be understood that similar arrows could be illustrated for each other input item 212-217.

There is no backward step of the first processing time step 241, because no output items have been generated and therefore no errors, gradients, or parameter updates can be computed.

In forward step of the second processing time step 242, the second layer block 220 processes the first block output generated in the preceding processing time step 241 (corresponding to the first input item 211) to generate a second block output. The first layer block 220 processes the second input item 212 to generate a new first block output.

There is no backward step of the second processing time step 242.

In the forward step of the third processing time step 243, the third layer block 230 processes the second block output generated in the preceding processing time step 242 (corresponding to the first input item 211) to generate the first output item 231. The second layer block 220 processes the first block output generated at the preceding processing time step 242 (corresponding to the second input item 212) to generate a new second block output. The first layer block 220 processes the third input item 213 to generate a new first block output.

In the backward step of the third processing time step 243, the third layer block 230 determines an error in the first output item 231. The third layer block 230 can determine a first gradient of the error, and provide the first gradient to the second layer block 220 (illustrated as a dashed arrow). The third layer block 230 can determine a second gradient of the error, and use the second gradient to determine a parameter update according to the error. Neither the second layer block 220 nor the first layer block 210 are active in the backward step of the third processing time step 243, because gradients have not yet been backpropagated to them.

In the forward step of the fourth processing time step 244, the third layer block 230 processes the second block output generated in the preceding processing time step 243 (corresponding to the second input item 212) to generate the second output item 232. The second layer block 220 processes the first block output generated at the preceding processing time step 243 (corresponding to the third input item 213) to generate a new second block output. The first layer block 220 processes the fourth input item 214 to generate a new first block output.

In the backward step of the fourth processing time step 244, the third layer block 230 determines an error in the second output item 232. The third layer block 230 determines the corresponding first and second gradients using the error. The second layer block 220 determines the corresponding first and second gradients using i) the preceding first gradient generated by the third layer block 230 in the third time step 243 (corresponding to the first input item 211) and ii) the block output of the first layer block 210 generated during the forward step of the third processing time step 243 (corresponding to the third input item 213). The first layer block 210 is not active in the backward step of the fourth processing time step 244.

In the forward step of the fifth processing time step 245, the third layer block 230 processes the second block output generated in the preceding processing time step 244 (corresponding to the third input item 213) to generate the third output item 233. The second layer block 220 processes the first block output generated at the preceding processing time step 244 (corresponding to the fourth input item 214) to generate a new second block output. The first layer block 220 processes the fifth input item 215 to generate a new first block output.

In the backward step of the fifth processing time step 245, the third layer block 230 determines an error in the third output item 233. The third layer block 230 determines the corresponding first and second gradients using the error. The second layer block 220 determines the corresponding first and second gradients using i) the preceding first gradient generated by the third layer block 230 in the fourth time step 244 (corresponding to the second input item 212) and ii) the block output of the first layer block 210 generated during the forward step of the fourth processing time step 244 (corresponding to the fourth input item 214). The first layer block 210 determines the corresponding second gradient using the preceding first gradient generated by the second layer block 220 in the fourth time step 244 (corresponding to the first input item 211).

This process continues for the sixth input item 216 and each subsequent input item in the input sequence.

Thus in implementations a layer output from one input item is combined with a gradient determined from a previous input item; and as the process continues data from multiple input items may be combined.

In some implementations, the training system can determine the first gradient for a layer block (i.e., the gradient that will be passed to the preceding layer block in the stack of layer blocks) by computing a first Jacobian of the layer block with respect to the block input of the layer block at the current processing time step. For the final layer block, the training system can determine the first gradient to be the first Jacobian. For each preceding layer block in the stack of layer blocks, the training system can generate the first gradient by multiplying the first Jacobian with the received preceding first gradient generated by the subsequent layer block in the stack of layer blocks at the preceding processing time step. The training system can then provide the first gradient to the preceding layer block in the stack of layer blocks to continue backpropagation in the subsequent processing time step.

Similarly, in some implementations, the training system can determine the second gradient for a layer block (i.e., the gradient that will be used to update the parameters of the layer block) by computing a second Jacobian of the layer block with respect to the current values of the parameters of the layer block. For the final layer block, the training system can determine the second gradient to be the second Jacobian. For each preceding layer block in the stack of layer blocks, the training system can then generate the second gradient by multiplying the second Jacobian with the received preceding first gradient generated by the subsequent layer block in the preceding processing time step. The training system can then generate a parameter update using the second gradient.

That is, during the backward pass corresponding to the k^{th} input item, the training system can determine the first gradient \tilde{∇}ₕ_{ᵢ₋₁}^{k} [symbol] for layer block i (i.e., the gradient that will be passed to the preceding layer block i−1 in the stack of layer blocks), by computing:

\tilde{∇}ₕ_{ᵢ₋₁}^{k} [symbol] =\tilde{∇}ₕ_{ᵢ}^{k} [symbol] ·JₕHᵢ(hᵢ₋₁^{k+2D-2n},θᵢ)

where there are D layer blocks in the neural network, \tilde{∇}ₕ_{ᵢ}^{k} [symbol] is the received preceding first gradient generated by the subsequent layer block i+1 in the preceding processing time step, Hᵢ is the function represented by layer block i, hᵢ₋₁^{k+2D-2n} is the block input for layer block i at the current processing time step (i.e., the block output generated by the preceding layer block i−1 at the preceding processing time step and corresponding to the (k+2D−2n)^{th} input item), θᵢ is the current set of parameter values of layer block i, and Jₕ is the Jacobian with respect to the block input, i.e., hᵢ₋₁^{k+2D-2n}.

Further, during the backward pass corresponding to the k^{th} input item, the training system can determine the second gradient \tilde{∇}_{θ}_{ᵢ}^{k} [symbol] for layer block i (i.e., the gradient that will be used to determine an update to the parameters θᵢ of layer block i), by computing:

\tilde{∇}_{θ}_{ᵢ}^{k} [symbol] =\tilde{∇}_{θ}_{ᵢ}^{k} [symbol] ·J_{θ}Hᵢ(hᵢ₋₁^{k+2D-2n},θᵢ)

where J_{θ} is the Jacobian with respect to the parameters θᵢ.

FIG. 2B illustrates the operations of the neural network across the final five processing time steps 251-255 corresponding to the input sequence. In particular, FIG. 2B illustrates that, in some implementations, after the block output corresponding to the K^{th} and final input item 218 has been generated by a respective layer block, the backward step of each subsequent processing time step performed by the subsequent layer block in the stack of layer blocks is executed using the block output corresponding to the K^{th} and final input item 218.

In particular, in the forward step of the K^{th} processing time step 251, the third layer block 230 processes the second block output generated in the preceding (K−1)^{th} processing time step (corresponding to the (K−2)^{th} input item) to generate the (K−2)^{th} output item 236. The second layer block 220 processes the first block output generated at the preceding (K−1)^{th} processing time step (corresponding to the (K−1)^{th} input item) to generate a new second block output. The first layer block 220 processes the K^{th} input item 218 to generate a new first block output.

In the backward step of the K^{th} processing time step 251, the third layer block 230 determines an error in the (K−2)^{th} output item 236. The third layer block 230 determines the corresponding first and second gradients using the error. The second layer block 220 determines the corresponding first and second gradients using i) the preceding first gradient generated by the third layer block 230 in the preceding (K−1)^{th} time step (corresponding to the (K−3)^{th} input item) and ii) the block output of the first layer block 210 generated during the forward step of the preceding (K−1)^{th} processing time step 250 (corresponding to the (K−1)^{th} input item). The first layer block 210 determines the corresponding second gradient using the preceding first gradient generated by the second layer block 220 in the preceding (K−1)^{th} time step (corresponding to the (K−4)^{th} input item).

In the forward step of the (K+1)^{th} processing time step 252, the third layer block 230 processes the second block output generated in the preceding K^{th} processing time step 251 (corresponding to the (K−1)^{th} input item) to generate the (K−1)^{th} output item 237. The second layer block 220 processes the first block output generated at the preceding K^{th} processing time step 251 (corresponding to the K^{th} input item) to generate a new second block output. The first layer block does not process any input items, because there are no input items left in the input sequence.

In the backward step of the (K+1)^{th} processing time step 252, the third layer block 230 determines an error in the (K−1)^{th} output item 237. The third layer block 230 determines the corresponding first and second gradients using the error. The second layer block 220 determines the corresponding first and second gradients using i) the preceding first gradient generated by the third layer block 230 in the preceding K^{th} time step 251 (corresponding to the (K−2)^{th} input item) and ii) the block output of the first layer block 210 generated during the forward step of the preceding K^{th} processing time step 251 (corresponding to the K^{th} input item 218). The first layer block 210 determines the corresponding second gradient using the preceding first gradient generated by the second layer block 220 in the preceding K^{th} time step 251 (corresponding to the (K−3)^{th} input item).

In the forward step of the (K+2)^{th} processing time step 253, the third layer block 230 processes the second block output generated in the preceding (K+1)^{th} processing time step 252 (corresponding to the K^{th} input item) to generate the K^{th} and final output item 238. Neither the second layer block nor the first layer block are active during the forward step of the (K+2)^{th} processing time step 253.

In the backward step of the (K+2)^{th} processing time step 253, the third layer block 230 determines an error in the K^{th} output item 238. The third layer block 230 determines the corresponding first and second gradients using the error. The second layer block 220 determines the corresponding first and second gradients using i) the preceding first gradient generated by the third layer block 230 in the preceding (K+1)^{th} time step 252 (corresponding to the (K−1)^{th} input item) and ii) the block output of the first layer block 210 generated during the forward step of the K^{th} processing time step 251 (corresponding to the K^{th} input item 219). The first layer block 210 determines the corresponding second gradient using the preceding first gradient generated by the second layer block 220 in the preceding (K+1)^{th} time step 252 (corresponding to the (K−2)^{th} input item).

There is no forward step of the (K+3)^{th} processing time step 254, as the K^{th} and final output item 238 has already been generated.

In the backward step of the (K+3)^{th} processing time step 254, the second layer block 220 determines the corresponding first and second gradients using i) the preceding first gradient generated by the third layer block 230 in the preceding (K+2)^{th} time step 253 (corresponding to the K^{th} input item) and ii) the block output of the first layer block 210 generated during the forward step of the K^{th} processing time step 251 (corresponding to the K^{th} input item 218). That is, the computed gradients are not an approximation, but rather an exact computation. The first layer block 210 determines the corresponding second gradient using the preceding first gradient generated by the second layer block 220 in the preceding (K+2)^{th} time step 253 (corresponding to the (K−1)^{th} input item) The third layer block 230 is not active in the backward step of the (K+3)^{th} processing time step 254.

There is no forward step of the (K+4)^{th} processing time step 255.

In the backward step of the (K+4)^{th} processing time step 255, the first layer block 210 determines the corresponding second gradient using the preceding first gradient generated by the second layer block 220 in the preceding (K+3)^{th} time step 253 (corresponding to the 10 input item). That is, the computed gradient is not an approximation, but rather is an exact computation. Neither the third layer block 230 nor the second layer block 220 are active in the backward step of the (K+4)^{th} processing time step 255.

Referring to both FIG. 2A and FIG. 2B, note that for some processing time steps 241-247 and 251-255, not every layer block is performing both a forward step and a backward step. In particular, there can be five phases of processing time steps.

In a first phase (in this example, corresponding to processing time steps 241-242), the forward pass of the first input item in the input sequence has not been completed; thus, only some of the layer blocks perform a forward step (in particular, the first m layer blocks in the stack of layer blocks perform a forward step at time m, where 1≤m<D), while none of the layer blocks perform a backward step.

In a second phase (in this example, corresponding to processing time steps 243-244), the forward pass of the first input item in the input sequence has been completed, but the backward pass of the first input item has not been completed; thus, every layer block performs a forward step, while only some of the layer blocks perform a backward step (in particular, the last r layer blocks in the stack of layer blocks perform a backward step at time r+D−1, where 1≤r<D), where D is the number of layer blocks in the neural network.

In a third phase (in this example, corresponding to processing time steps 245-247 and 251), every layer block performs both a forward step and a backward step, as described above.

In a fourth phase (in this example, corresponding to processing time steps 252-253), the forward pass of the final input item in the input sequence has begun but has not been completed; thus, only some of the layer blocks perform a forward step (in particular, the last p layer blocks in the stack of layer blocks perform a forward step if the system has completed D−p steps of the forward pass of the final input item), while every layer block performs a backward step.

In a fifth phase (in this example, corresponding to processing time steps 254-255), the backward pass of the final input item in the input sequence has begun but has not been completed; thus, none of the layer blocks perform a forward step, while only some of the layer blocks perform a backward step (in particular, the first q layers blocks in the stack of layer blocks perform a backward step if the system has completed D−q steps of the backward pass of the final input item).

During the fourth and fifth phases, some of the layer blocks in the stack of layer blocks perform a backward step even though the respective preceding layer blocks in the stack of layer blocks did not perform a forward step in the preceding processing time step. In order to do so, a given layer block can compute the corresponding first and second gradients using the most recent block output that the preceding layer block generated, i.e., the block output generated by the preceding layer block during the final forward step that the preceding layer block performed.

In some implementations, the training system can update each layer block at each processing time step using the respective computed parameter update. In some other implementations, the system can first process the entire input sequence using the neural network; then, for each layer block, the training system can combine the parameter updates computed for the layer block corresponding to respective input items in the input sequence, and update the parameters of the layer block using the combined parameter update.

As a particular example, the training system can update the parameters of the layer block using the average of the parameter updates, i.e., compute for each layer block i:

$${\tilde{∇}}_{{θ}_{i}} ℒ = \frac{1}{K} {\sum }_{k = 1}^{K} {\tilde{∇}}_{{θ}_{i}}^{k} ℒ$$

where K is the number of input items in the input sequence.

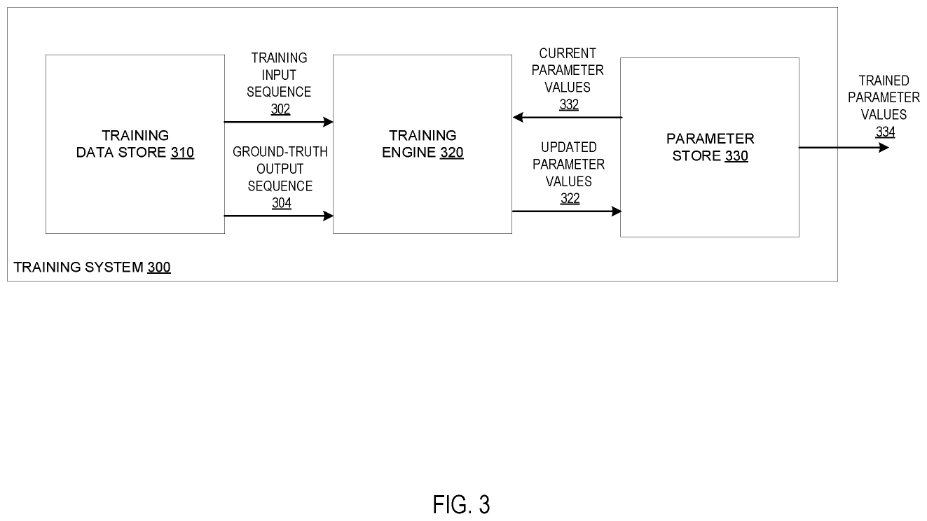

FIG. 3 is a block diagram of an example training system 300. The training system 300 is an example. The training system 300 is an example of a system implemented as computer programs on one or more computers in one or more locations in which the systems, components, and techniques described below are implemented.

The training system 300 is configured to train a neural network to receive an input sequence and to process the input sequence to generate an output sequence. In particular, the training system 300 is configured to train the neural network by executing multiple forward passes and multiple backward passes, each corresponding to a respective input item in the input sequence, in parallel, as described above with reference to FIGS. 2A and 2B. The training system includes a training data store 310, a training engine 320, and a parameter store 330.

The training data store 310 is configured to store training examples for training the neural network. Each training example can include a training input sequence and a ground-truth output sequence that represents the output sequence that the neural network should generate in response to processing the input sequence.

The parameter store 330 is configured to store the current values for the parameters of the neural network.

The training engine 320 is configured to execute training of the neural network, i.e., to determine updates to the parameters of the neural network. In particular, at each of multiple training time steps, the training engine 320 obtains i) a training input sequence 302 and ii) the ground-truth output sequence 304 corresponding to the training input sequence 302 from the training data store. The training engine 320 can also obtain the current values 332 of the parameters of the neural network from the parameter store 330.

At each of multiple processing time steps, as described above with respect to FIGS. 2A and 2B, the training engine 320 processes multiple input item of the training input sequence 302 in parallel, and determines an update to the current values 332 of the parameters of the neural network according to a difference between i) the output items generated by the neural network and ii) the ground-truth output items identified in the ground-truth output sequence 304.

In some implementations, the training engine 320 updates the parameters of the neural network at each processing time step. In some other implementations, the training engine 320 updates the parameters of the neural network in batches of multiple processing time steps. That is, for each of multiple layer blocks of the neural network, the training engine 320 can determine a combined parameter update for the layer block using the respective updates determined at each processing time step in the batch of processing time steps. For example, the training engine 320 can determine the average parameter update across the batch of processing time steps.

After processing the training input sequence 302 and updating the parameters of the neural network, the training engine 320 can provide the updated parameter values 322 to the parameter store 330.

After training is completed, the training system 300 can output the final trained values 334 of the parameters of the neural network. In some implementations, the training system 300 can determine to complete training after processing a predetermined number of training examples. In some other implementations, the training system 300 can determine to complete training after a performance metric (e.g., prediction accuracy of a validation or testing data set) of the neural network exceeds a predetermined threshold. In some other implementations, the training system 300 can determine to complete training after an incremental improvement of the performance metric of the neural network across multiple training time steps drops below a predetermined threshold, i.e., after the performance of the neural network is no longer significantly improving.

For example, the training system 300 can provide the trained parameter values 334 to an inference system that is configured to receive input sequences and to process the input sequences using the trained neural network to generate network outputs. In some implementations, the inference system can be deployed on a local device of a user. In some other implementations, the inference system can be deployed onto a cloud system, i.e., a distributed computing system having multiple computing nodes, e.g., hundreds or thousands of computing nodes, in one or more locations.

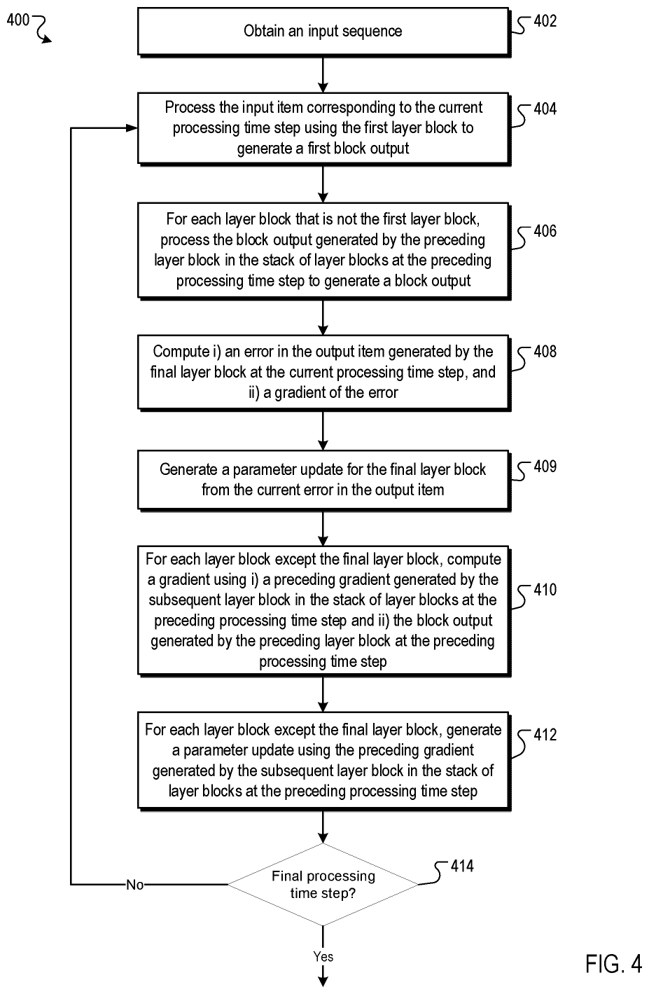

FIG. 4 is a flow diagram of an example process 400 for training a neural network. For convenience, the process 400 will be described as being performed by a system of one or more computers located in one or more locations. For example, a training system, e.g., the training system 300 depicted in FIG. 3, appropriately programmed in accordance with this specification, can perform the process 400.

The neural network is configured to process an input sequence that includes a respective input item at each of multiple input time steps, and to generate a network output for the input sequence. In particular, the neural network generates a respective output item for each input item in the input sequence. The neural network includes a stack of layer blocks, where each layer block includes one or more neural network layers.

The system obtains an input sequence (step 402).

At each of multiple processing time steps in a sequence of processing time steps, the system performs steps 404-414. The sequence of processing time steps can correspond to the third phase described above with respect to FIGS. 2A and 2B.

The system processes the input item corresponding to the current processing time step using the first layer block in the stack of layer blocks to generate a first block output (step 404).

For each layer block in the stack of layer blocks that is not the first layer block, the system processes the block output generated by the preceding layer block in the stack of layer blocks at the preceding processing time step to generate a block output (step 406). The block output generated by the final layer block in the stack of layer blocks can be the output item for the input item corresponding to a preceding input time step.

The system computes i) an error in the output item generated by the final layer block at the current processing time step and ii) a gradient of the error for the final layer block (step 408).

The system generates a parameter update for the final layer block from the current error in the output item (step 409).

For each layer block that is not the final layer block, the system computes a gradient using i) a preceding gradient generated by the subsequent layer block in the stack of layer blocks at the preceding processing time step, and ii) the block output generated by the preceding layer block in the stack of layer blocks at the preceding processing time step in the sequence of processing time steps (step 410).

For each layer block that is not the final layer block, the system generates a parameter update for the layer block from the preceding gradient generated by the subsequent layer block in the stack of layer blocks at the preceding processing time step (step 412).

The system determines whether the current processing time step is the final processing time step in the sequence of processing time steps (step 414).

If the current processing time step if the final processing time step, the system terminates the process 400.

If the current processing time step is not the final processing time step, then the system returns to step 404 at the subsequent processing time step in the sequence of processing time steps.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML, page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method of training a neural network configured to process an input sequence and to generate a network output for the input sequence, wherein:

the neural network generates a respective output item for each of a plurality of input items in the input sequence, and

the neural network comprises a stack of layer blocks, each layer block comprising one or more neural network layers, the stack of layer blocks comprising a first layer block and a final layer block,

wherein the training comprises:

receiving an input sequence comprising a respective input item at each of a plurality of input time steps; and

at each of a plurality of processing time steps in a sequence of processing time steps:
processing the input item of an input time step corresponding to the processing time step using the first layer block to generate a first block output;
for each particular layer block that is not the first layer block, processing a block output generated by the preceding layer block in the stack of layer blocks at the preceding processing time step in the sequence of processing time steps using the particular layer block to generate a current block output, wherein the current block output generated by the final layer block is the output item for an input item of an earlier input time step than the input time step corresponding to the processing time step;
computing i) a current error in the output item generated by the final layer block at the processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the preceding block output generated by the preceding layer block in the stack of layer blocks at the preceding processing time step in the sequence of processing time steps; and
for each particular layer block that is not the final layer block, generating a parameter update for the particular layer block from the preceding gradient computed by the subsequent layer block in the stack of layer blocks at the preceding processing time step in the sequence of processing time steps.

Embodiment 2 is the method of embodiment 1, further comprising, at each of a plurality of second processing time steps in a sequence of second processing time steps:

processing the input item of an input time step corresponding to the second processing time step using the first layer block to generate a first block output; and

for each particular layer block that is not the first layer block, processing a block output generated by the preceding layer block in the stack of layer blocks at the preceding second processing time step in the sequence of second processing time steps using the particular layer block to generate a current block output, wherein the current block output generated by the final layer block is the output item for an input item of an earlier input time step than the input time step corresponding to the second processing time step;

computing i) a current error in the output item generated by the final layer block at the second processing time step and ii) a current gradient of the current error for the final layer block;

generating a parameter update for the final layer block from the current error in the output item; and

for each particular layer block that is not the final layer block and for which the subsequent layer block in the stack of layer blocks computed a preceding gradient at the preceding second processing time step in the sequence of second processing time steps:
computing a current gradient for the particular layer block in the stack of layer blocks from i) the preceding gradient computed by the subsequent layer block at the preceding second processing time step and ii) the current block output generated by the preceding layer block in the stack of layer blocks at the preceding second processing time step; and
generating a parameter update for the particular layer block in the stack of layer blocks from the preceding gradient computed by the subsequent layer block at the preceding second processing time step,

wherein the sequence of second processing time steps precedes the sequence of processing time steps.

Embodiment 3 is the method of any one of embodiments 1 or 2, further comprising, at each of a plurality of third processing time steps in a sequence of third processing time steps:

for each particular layer block that i) generated a preceding block output at the preceding third processing time step in the sequence of third processing time steps and ii) is not the final layer block, processing the preceding block output generated by the particular layer block at the preceding third processing time step using the subsequent layer block in the stack of layer blocks to generate a current block output, wherein the current block output generated by the final layer block is the output item for an input item of an earlier input time step than the input time step corresponding to the third processing time step;

computing i) a current error in the output item generated by the final layer block at the third processing time step and ii) a current gradient of the current error for the final layer block;

generating a parameter update for the final layer block from the current error in the output item;

for each particular layer block that is not the final layer block, computing a current gradient for the particular layer block from i) a preceding gradient computed by the subsequent layer block in the stack of layer blocks at the preceding processing time step in the sequence of processing time steps and ii) the current block output generated by the particular layer block at the processing time step; and

for each particular layer block that is not the final layer block, generating a parameter update for the particular layer block from the preceding gradient computed by the subsequent layer block in the stack of layer blocks at the preceding processing time step in the sequence of processing time steps,

wherein the sequence of third processing time steps succeeds the sequence of processing time steps.

Embodiment 4 is the method of any one of embodiments 1-3, further comprising, at each of a plurality of fourth processing time steps in a sequence of fourth processing time steps:

for each particular layer block that is not the final layer block and for which the subsequent layer block in the stack of layer block computed a preceding gradient at the preceding fourth processing time step in the sequence of fourth processing time steps:
computing a current gradient for the particular layer block in the stack of layer blocks from i) the preceding gradient computed by the subsequent layer block at the preceding fourth processing time step and ii) the block output most recently generated by the preceding layer block in the stack of layer blocks; and
generating a parameter update for the particular layer block in the stack of layer blocks from the preceding gradient computed by the subsequent layer block at the preceding second processing time step,

wherein the sequence of fourth processing time steps succeeds the sequence of processing time steps.

Embodiment 5 is the method of any one of embodiments 1-4, wherein computing a current gradient for a particular layer block that is not the final layer block comprises:

computing a first Jacobian of the particular layer block with respect to the block output generated by the preceding layer block in the stack of layer blocks at the preceding processing time step; and

multiplying the first Jacobian with the preceding gradient computed by the subsequent layer block in the stack of layer blocks at the preceding processing time step in the sequence of processing time steps.

Embodiment 6 is the method of any one of embodiments 1-5, wherein computing a current gradient for the final layer block comprises:

computing a first Jacobian of the final layer block with respect to the block output generated by the preceding layer block in the stack of layer blocks at the preceding processing time step.

Embodiment 7 is the method of any one of embodiments 1-6, wherein generating a parameter update for a particular layer block that is not the final layer block comprises:

generating a second gradient for the particular layer block, comprising:
computing a second Jacobian of the particular layer block with respect to current values of the parameters of the particular layer block; and
multiplying the second Jacobian with the preceding gradient computed by the subsequent layer block in the stack of layer blocks at the preceding processing time step in the sequence of processing time steps; and

generating the parameter update from the second gradient.

Embodiment 8 is the method of any one of embodiments 1-7, wherein generating a parameter update for the final layer block comprises:

generating a second gradient for the final layer block, comprising:
computing a second Jacobian of the final layer block with respect to current values of the parameters of the final layer block; and

generating the parameter update from the second gradient.

Embodiment 9 is the method of any one of embodiments 1-8, wherein generating a parameter update comprises generating the parameter update using stochastic gradient descent.

Embodiment 10 is the method of any one of embodiments 1-9, further comprising, for each layer block:

combining the parameter updates for the layer block generated at a plurality of respective processing time steps to generate a combined parameter update, and

updating parameters of the layer block using the combined parameter update.

Embodiment 11 is a system comprising: one or more computers and one or more storage devices storing instructions that are operable, when executed by the one or more computers, to cause the one or more computers to perform the method of any one of embodiments 1 to 10.

Embodiment 12 is one or more non-transitory computer storage medium encoded with a computer program, the program comprising instructions that are operable, when executed by data processing apparatus, to cause the data processing apparatus to perform the method of any one of embodiments 1 to 10.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of training a neural network configured to process an input sequence and to generate a network output for the input sequence, wherein:
the neural network generates a respective output item for each of a plurality of input items in the input sequence, and
the neural network comprises a stack of layer blocks, each layer block comprising one or more neural network layers, the stack of layer blocks comprising a first layer block and a final layer block,
wherein the training comprises:
receiving an input sequence comprising a respective input item at each of a plurality of input time steps; and
at each of a plurality of processing time steps in a sequence of processing time steps:
processing the input item of an input time step corresponding to the processing time step using the first layer block to generate a first block output;
for each particular layer block that is not the first layer block, processing a block output generated by the preceding layer block in the stack of layer blocks at the preceding processing time step in the sequence of processing time steps using the particular layer block to generate a current block output, wherein the current block output generated by the final layer block is the output item for an input item of an earlier input time step than the input time step corresponding to the processing time step;
computing i) a current error in the output item generated by the final layer block at the processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the preceding block output generated by the preceding layer block in the stack of layer blocks at the preceding processing time step in the sequence of processing time steps; and
for each particular layer block that is not the final layer block, generating a parameter update for the particular layer block from the preceding gradient computed by the subsequent layer block in the stack of layer blocks at the preceding processing time step in the sequence of processing time steps.

2. The method of claim 1, further comprising, at each of a plurality of second processing time steps in a sequence of second processing time steps:
processing the input item of an input time step corresponding to the second processing time step using the first layer block to generate a first block output; and
for each particular layer block that is not the first layer block, processing a block output generated by the preceding layer block in the stack of layer blocks at the preceding second processing time step in the sequence of second processing time steps using the particular layer block to generate a current block output, wherein the current block output generated by the final layer block is the output item for an input item of an earlier input time step than the input time step corresponding to the second processing time step;
computing i) a current error in the output item generated by the final layer block at the second processing time step and ii) a current gradient of the current error for the final layer block;
generating a parameter update for the final layer block from the current error in the output item; and
for each particular layer block that is not the final layer block and for which the subsequent layer block in the stack of layer blocks computed a preceding gradient at the preceding second processing time step in the sequence of second processing time steps:
computing a current gradient for the particular layer block in the stack of layer blocks from i) the preceding gradient computed by the subsequent layer block at the preceding second processing time step and ii) the current block output generated by the preceding layer block in the stack of layer blocks at the preceding second processing time step; and
generating a parameter update for the particular layer block in the stack of layer blocks from the preceding gradient computed by the subsequent layer block at the preceding second processing time step,
wherein the sequence of second processing time steps precedes the sequence of processing time steps.

3. The method of claim 1, further comprising, at each of a plurality of third processing time steps in a sequence of third processing time steps:
for each particular layer block that i) generated a preceding block output at the preceding third processing time step in the sequence of third processing time steps and ii) is not the final layer block, processing the preceding block output generated by the particular layer block at the preceding third processing time step using the subsequent layer block in the stack of layer blocks to generate a current block output, wherein the current block output generated by the final layer block is the output item for an input item of an earlier input time step than the input time step corresponding to the third processing time step;
computing i) a current error in the output item generated by the final layer block at the third processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the current block output generated by the particular layer block at the processing time step; and
for each particular layer block that is not the final layer block, generating a parameter update for the particular layer block from the preceding gradient computed by the subsequent layer block in the stack of layer blocks at the preceding processing time step in the sequence of processing time steps,
wherein the sequence of third processing time steps succeeds the sequence of processing time steps.

4. The method of claim 1, further comprising, at each of a plurality of fourth processing time steps in a sequence of fourth processing time steps:
for each particular layer block that is not the final layer block and for which the subsequent layer block in the stack of layer block computed a preceding gradient at the preceding fourth processing time step in the sequence of fourth processing time steps:
computing a current gradient for the particular layer block in the stack of layer blocks from i) the preceding gradient computed by the subsequent layer block at the preceding fourth processing time step and ii) the block output most recently generated by the preceding layer block in the stack of layer blocks; and
generating a parameter update for the particular layer block in the stack of layer blocks from the preceding gradient computed by the subsequent layer block at the preceding second processing time step,
wherein the sequence of fourth processing time steps succeeds the sequence of processing time steps.

5. The method of claim 1, wherein computing a current gradient for a particular layer block that is not the final layer block comprises:
computing a first Jacobian of the particular layer block with respect to the block output generated by the preceding layer block in the stack of layer blocks at the preceding processing time step; and
multiplying the first Jacobian with the preceding gradient computed by the subsequent layer block in the stack of layer blocks at the preceding processing time step in the sequence of processing time steps.

6. The method of claim 1, wherein computing a current gradient for the final layer block comprises:
computing a first Jacobian of the final layer block with respect to the block output generated by the preceding layer block in the stack of layer blocks at the preceding processing time step.

7. The method of claim 1, wherein generating a parameter update for a particular layer block that is not the final layer block comprises:
generating a second gradient for the particular layer block, comprising:
computing a second Jacobian of the particular layer block with respect to current values of the parameters of the particular layer block; and
multiplying the second Jacobian with the preceding gradient computed by the subsequent layer block in the stack of layer blocks at the preceding processing time step in the sequence of processing time steps; and
generating the parameter update from the second gradient.

8. The method claim 1, wherein generating a parameter update for the final layer block comprises:
generating a second gradient for the final layer block, comprising:
computing a second Jacobian of the final layer block with respect to current values of the parameters of the final layer block; and
generating the parameter update from the second gradient.

9. The method of claim 1, wherein generating a parameter update comprises generating the parameter update using stochastic gradient descent.

10. The method of claim 1, further comprising, for each layer block:
combining the parameter updates for the layer block generated at a plurality of respective processing time steps to generate a combined parameter update, and
updating parameters of the layer block using the combined parameter update.

11. (canceled)

12. One or more non-transitory computer storage media storing instructions that when executed by one or more computers cause the one more computers to perform operations for training a neural network configured to process an input sequence and to generate a network output for the input sequence, wherein:
the neural network generates a respective output item for each of a plurality of input items in the input sequence, and
the neural network comprises a stack of layer blocks, each layer block comprising one or more neural network layers, the stack of layer blocks comprising a first layer block and a final layer block,
wherein the operations comprise:
receiving an input sequence comprising a respective input item at each of a plurality of input time steps; and
at each of a plurality of processing time steps in a sequence of processing time steps:
processing the input item of an input time step corresponding to the processing time step using the first layer block to generate a first block output;
for each particular layer block that is not the first layer block, processing a block output generated by the preceding layer block in the stack of layer blocks at the preceding processing time step in the sequence of processing time steps using the particular layer block to generate a current block output, wherein the current block output generated by the final layer block is the output item for an input item of an earlier input time step than the input time step corresponding to the processing time step;
computing i) a current error in the output item generated by the final layer block at the processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the preceding block output generated by the preceding layer block in the stack of layer blocks at the preceding processing time step in the sequence of processing time steps; and
for each particular layer block that is not the final layer block, generating a parameter update for the particular layer block from the preceding gradient computed by the subsequent layer block in the stack of layer blocks at the preceding processing time step in the sequence of processing time steps.

13. A system comprising one or more computers and one or more storage devices storing instructions that when executed by one or more computers cause the one or more computers to perform operations for training a neural network configured to process an input sequence and to generate a network output for the input sequence, wherein:
the neural network generates a respective output item for each of a plurality of input items in the input sequence, and
the neural network comprises a stack of layer blocks, each layer block comprising one or more neural network layers, the stack of layer blocks comprising a first layer block and a final layer block,
wherein the operations comprise:
receiving an input sequence comprising a respective input item at each of a plurality of input time steps; and
at each of a plurality of processing time steps in a sequence of processing time steps:
processing the input item of an input time step corresponding to the processing time step using the first layer block to generate a first block output;
for each particular layer block that is not the first layer block, processing a block output generated by the preceding layer block in the stack of layer blocks at the preceding processing time step in the sequence of processing time steps using the particular layer block to generate a current block output, wherein the current block output generated by the final layer block is the output item for an input item of an earlier input time step than the input time step corresponding to the processing time step;
computing i) a current error in the output item generated by the final layer block at the processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the preceding block output generated by the preceding layer block in the stack of layer blocks at the preceding processing time step in the sequence of processing time steps; and
for each particular layer block that is not the final layer block, generating a parameter update for the particular layer block from the preceding gradient computed by the subsequent layer block in the stack of layer blocks at the preceding processing time step in the sequence of processing time steps.

14. The system of claim 13, the operations further comprising, at each of a plurality of second processing time steps in a sequence of second processing time steps:
processing the input item of an input time step corresponding to the second processing time step using the first layer block to generate a first block output; and
for each particular layer block that is not the first layer block, processing a block output generated by the preceding layer block in the stack of layer blocks at the preceding second processing time step in the sequence of second processing time steps using the particular layer block to generate a current block output, wherein the current block output generated by the final layer block is the output item for an input item of an earlier input time step than the input time step corresponding to the second processing time step;
computing i) a current error in the output item generated by the final layer block at the second processing time step and ii) a current gradient of the current error for the final layer block;
generating a parameter update for the final layer block from the current error in the output item; and
for each particular layer block that is not the final layer block and for which the subsequent layer block in the stack of layer blocks computed a preceding gradient at the preceding second processing time step in the sequence of second processing time steps:
computing a current gradient for the particular layer block in the stack of layer blocks from i) the preceding gradient computed by the subsequent layer block at the preceding second processing time step and ii) the current block output generated by the preceding layer block in the stack of layer blocks at the preceding second processing time step; and
generating a parameter update for the particular layer block in the stack of layer blocks from the preceding gradient computed by the subsequent layer block at the preceding second processing time step,
wherein the sequence of second processing time steps precedes the sequence of processing time steps.

15. The system of claim 13, the operations further comprising, at each of a plurality of third processing time steps in a sequence of third processing time steps:
for each particular layer block that i) generated a preceding block output at the preceding third processing time step in the sequence of third processing time steps and ii) is not the final layer block, processing the preceding block output generated by the particular layer block at the preceding third processing time step using the subsequent layer block in the stack of layer blocks to generate a current block output, wherein the current block output generated by the final layer block is the output item for an input item of an earlier input time step than the input time step corresponding to the third processing time step;
computing i) a current error in the output item generated by the final layer block at the third processing time step and ii) a current gradient of the current error for the final layer block;
generating a parameter update for the final layer block from the current error in the output item;
for each particular layer block that is not the final layer block, computing a current gradient for the particular layer block from i) a preceding gradient computed by the subsequent layer block in the stack of layer blocks at the preceding processing time step in the sequence of processing time steps and ii) the current block output generated by the particular layer block at the processing time step; and
for each particular layer block that is not the final layer block, generating a parameter update for the particular layer block from the preceding gradient computed by the subsequent layer block in the stack of layer blocks at the preceding processing time step in the sequence of processing time steps,
wherein the sequence of third processing time steps succeeds the sequence of processing time steps.

16. The system of claim 13, the operations further comprising, at each of a plurality of fourth processing time steps in a sequence of fourth processing time steps:
for each particular layer block that is not the final layer block and for which the subsequent layer block in the stack of layer block computed a preceding gradient at the preceding fourth processing time step in the sequence of fourth processing time steps:
computing a current gradient for the particular layer block in the stack of layer blocks from i) the preceding gradient computed by the subsequent layer block at the preceding fourth processing time step and ii) the block output most recently generated by the preceding layer block in the stack of layer blocks; and
generating a parameter update for the particular layer block in the stack of layer blocks from the preceding gradient computed by the subsequent layer block at the preceding second processing time step,
wherein the sequence of fourth processing time steps succeeds the sequence of processing time steps.

17. The system of claim 13, wherein computing a current gradient for a particular layer block that is not the final layer block comprises:
computing a first Jacobian of the particular layer block with respect to the block output generated by the preceding layer block in the stack of layer blocks at the preceding processing time step; and
multiplying the first Jacobian with the preceding gradient computed by the subsequent layer block in the stack of layer blocks at the preceding processing time step in the sequence of processing time steps.

18. The system of claim 13, wherein computing a current gradient for the final layer block comprises:
computing a first Jacobian of the final layer block with respect to the block output generated by the preceding layer block in the stack of layer blocks at the preceding processing time step.

19. The system of claim 13, wherein generating a parameter update for a particular layer block that is not the final layer block comprises:
generating a second gradient for the particular layer block, comprising:
computing a second Jacobian of the particular layer block with respect to current values of the parameters of the particular layer block; and
multiplying the second Jacobian with the preceding gradient computed by the subsequent layer block in the stack of layer blocks at the preceding processing time step in the sequence of processing time steps; and
generating the parameter update from the second gradient.

20. The system claim 13, wherein generating a parameter update for the final layer block comprises:
generating a second gradient for the final layer block, comprising:
computing a second Jacobian of the final layer block with respect to current values of the parameters of the final layer block; and
generating the parameter update from the second gradient.

21. The system of claim 13, wherein generating a parameter update comprises generating the parameter update using stochastic gradient descent.
